(19) United States
(12) Patent Application Publication
(10) Pub. No.: US 2025/0227608 A1
(43) Pub. Date: Jul. 10, 2025

(54) METHODS, DEVICES, AND COMPUTER READABLE MEDIUM FOR COMMUNICATION

(71) Applicant: NEC CORPORATION, Tokyo (JP)

(72) Inventor: Gang WANG, Beijing (CN)

(73) Assignee: NEC CORPORATION, Tokyo (JP)

(21) Appl. No.: 18/847,507

(22) PCT Filed: Mar. 18, 2022
(86) PCT No.: PCT/CN2022/081776

§ 371 Date: Sep. 16, 2024

(51) Int. Cl. H04W 52/02

(52) U.S. Cl. CPC H04W 52/0206

(57) ABSTRACT

Embodiments of the present disclosure relate to methods, devices, and computer readable medium for communication. According to embodiments of the present disclosure, a first apparatus receives energy saving information from a second apparatus. The energy saving information comprises a set of energy saving configurations. A energy saving configuration indicates one or more of a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied. The first apparatus transmits an indication of an active energy saving configuration to the second apparatus. In this way, the balance between energy saving and communication performances can be achieved.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, in previous releases of new radio (NR), power saving at user equipment (UE) side has been intensively studied and specified. Moreover, a new study item of network energy saving also needs to be considered, which focuses on the energy saving at network device side.

### SUMMARY

In general, example embodiments of the present disclosure provide a solution for communication.

In a first aspect, there is provided a method for communication. The method comprises: receiving, at a centralized unit (CU) of a network device, energy saving information from a distributed unit (DU) of the network device, the energy saving information comprising a set of energy saving configurations, and an energy saving configuration in the set of energy saving configurations indicating at least one of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied; and transmitting, to the DU, an indication of an active energy saving configuration from the set energy saving configurations, wherein the active energy saving configuration is to be activated for at least one cell.

In a second aspect, there is provided a method for communication. The method comprises transmitting, at a distributed unit (DU) of a network device, energy saving information to a centralized unit (CU) of the network device, the energy saving information comprising a set of energy saving configurations, and an energy saving configuration in the set of energy saving configurations indicating at least one of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied; and receiving, from the CU, an indication of an active energy saving configuration from the set energy saving configurations, wherein the active energy saving configuration is to be activated for at least one cell.

In a third aspect, there is provided a first apparatus. The first apparatus comprises a processing unit; and a memory coupled to the processing unit and storing instructions thereon, the instructions, when executed by the processing unit, causing the first apparatus to perform acts comprising: receiving from a second apparatus, the energy saving information comprising a set of energy saving configurations, and an energy saving configuration in the set of energy saving configurations indicating at least one of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied; and transmitting, to the second apparatus, an indication of an active energy saving configuration from the set energy saving configurations, wherein the active energy saving configuration is to be activated for at least one cell.

In a fourth aspect, there is provided a second apparatus. The second apparatus comprises a processing unit; and a memory coupled to the processing unit and storing instructions thereon, the instructions, when executed by the processing unit, causing the second apparatus to perform acts comprising: transmitting, to a second apparatus, the energy saving information comprising a set of energy saving configurations, and an energy saving configuration in the set of energy saving configurations indicating at least one of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied; and receiving, from the first apparatus, an indication of an active energy saving configuration from the set energy saving configurations, wherein the active energy saving configuration is to be activated for at least one cell.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 is a flowchart of an example method in accordance with an embodiment of the present disclosure;

FIG. 4 is a flowchart of an example method in accordance with an embodiment of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, a new study item of network energy saving also needs to be considered, which focuses on the energy saving at network device side. In previous studies, energy saving is supported in the self-organizing network (SON) and Operation and Maintenance (Q&M) topics. The main idea of existing energy saving scheme is to support cell deactivation and activation for a gNB or a gNB-distributed unit (gNB-DU) based on the load information. This can work in carrier aggregation (CA) or heterogeneous network cases, however, a cell can only have two status in this method, i.e., active or inactive status, there is no in-between status to provide finer granularity for energy saving.

However, it is beneficial to study how to reduce energy consumption for a particular cell with finer granularity of energy saving level. For example, for a gNB with light-to-medium load, it may temporarily stop the transmission/reception, or de-activate a portion of the antenna ports, or reduce the channel bandwidth (by changing the BWP), to save energy. Therefore, the interface between network devices and the interface between units of a split-architecture of the network device should be enhanced to support the finer energy saving granularity.

If the finer energy saving granularity is introduced, a cell may have multiple levels of energy saving, and each of the energy saving level is associated with an antenna configuration, power configuration, bandwidth configuration and/or time domain resource configuration. For a gNB centralized unit (CU)-DU split architecture, the supported energy saving levels and the conditions to apply the energy saving levels may mainly rely on the gNB-DU, since the physical layer functions (i.e., the main power hungry modules) are located at gNB-DU. However the decision of activation and switching of an energy saving level may be made by gNB-CU since the RRC function is located at gNB-CU.

Therefore, new F1 procedures may be needed to exchange the information of the supported energy saving configurations between gNB-CU and gNB-DU, and to inform or request energy saving configuration activation/switch by gNB-CU or gNB-DU. Similarly, new Xn procedures related to energy saving may be also needed to enable interoperation and resource/interference coordination among gNBs.

In order to solve at least part of the above problems or other potential problems, solutions on network energy saving are proposed. According to embodiments of the present disclosure, a first apparatus receives energy saving information from a second apparatus. The energy saving information comprises a set of energy saving configurations. A energy saving configuration indicates one or more of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied. The first apparatus transmits an indication of an active energy saving configuration to the second apparatus. In this way, the balance between energy saving and communication performances can be achieved.

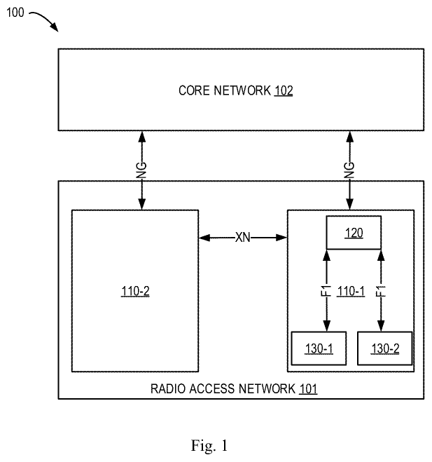

FIG. 1 illustrates a schematic diagram of a communication system in which embodiments of the present disclosure can be implemented. The communication system 100 comprises a radio access network (RAN) 101 and a core network 102. As shown in FIG. 1, the RAN 101 may comprise a set of gNBs (for example, the gNB 110-1 and the gNB 110-2) connected to the core network 120 through NG interface. The gNBs can be interconnected through Xn interface. For example, as shown in FIG. 1, the gNB 110-1 and the gNB 110-2 can be interconnected through the Xn interface. The numbers of devices/entities shown in FIG. 1 are given for the purpose of illustration without suggesting any limitations.

A gNB may comprise a gNB-CU and one or more gNB-DU(s). For example, as shown in FIG. 1, the gNB 110-1 may comprise the gNB-CU 120 and two gNB-DUs 130-1 and 130-2. A gNB-CU and a gNB-DU can be connected via F1 interface. The term “centralized unit (CU)” used herein can refer to a logical node that includes the gNB functions like Transfer of user data, Mobility control, Radio access network sharing, Positioning, Session Management etc., except those functions allocated exclusively to the DU. CU controls the operation of DUs over front-haul interface. The term “distributed unit (DU)” used herein can refer to a logical node that includes a subset of the gNB functions, depending on the functional split option. Its operation is controlled by the CU. The radio resource control (RRC), service data adaptation protocol (SDAP) and packet data convergence protocol (PDCP) layers are hosted by gNB-CU, and the radio link control (RLC), medium access control (MAC) and physical (PHY) layers are hosted by gNB-DU.

A gNB-CU may be split to a gNB-CU-CP and multiple gNB-CU-UPs to host control plane and user plane functions respectively. The gNB-CU-CP is connected to the gNB-DU through the F1-C interface; the gNB-CU-UP is connected to the gNB-DU through the F1-U interface; the gNB-CU-UP is connected to the gNB-CU-CP through the E1 interface.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IoT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

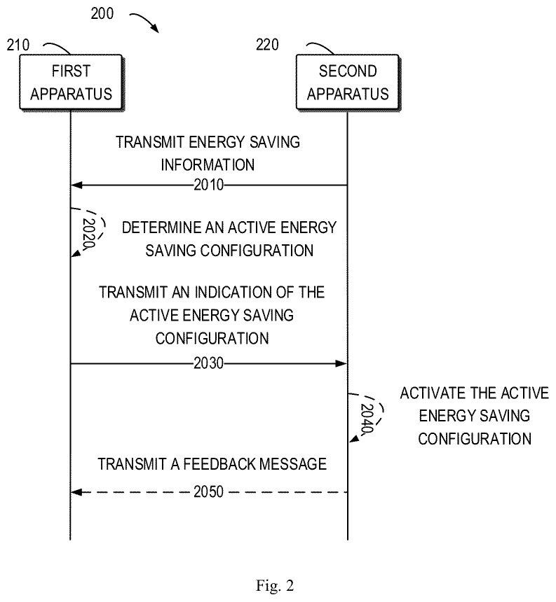

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. The process 200 involves the first apparatus 210 and the second apparatus 220. In some embodiments, the first apparatus 210 may be a CU of the network device (for example, the gNB-CU 120) and the second apparatus 220 may be a DU of the network device (for example, the gNB-DU 130-1 or 130-2). Alternatively, in some embodiments, the first apparatus 210 may be a network device (for example, the gNB 110-1) and the second apparatus 220 may be another network device (for example, the gNB 110-2).

The second apparatus 220 transmits 2010 energy saving information to the first apparatus 210. In some embodiments, the energy saving information may be transmitted using an energy saving information procedure. Alternatively, in some embodiments, if the first apparatus 210 is the gNB-CU 120 and the second apparatus 220 is the gNB-DU 130-1, the energy saving information may be included in a gNB-DU configuration update message which may be transmitted from the gNB-DU 130-1 to the gNB-CU 120. In this case, the gNB-DU configuration update message may also comprise one or more of: a cells-to-be-activated-list item information element (IE) or a cells-to-be-deactivated-list item IE. In this way, if the first apparatus 210 is a gNB-CU and the second apparatus 220 is a gNB-DU, a gNB-DU can have multiple energy saving levels with different settings, which is beneficial to get balance between energy saving and performance. Moreover, it is beneficial for the interoperation between the gNB-CU and the gNB-DU, especially for the inter-vendor cases. The gNB-CU can be aware of the energy saving capability of a gNB-DU as well as the application condition and the expected energy saving level. Then gNB-CU can make decisions to activate/deactivate an energy saving configuration when necessary. In another situation where both the first apparatus 210 and the second apparatus 220 are network devices, since there may be a header network device to coordinate the energy saving settings among a group of network devices, it is beneficial to allow network devices exchange the information of energy saving settings. Moreover, since the energy saving configurations may have impact on the coverage, performance and interference, it is beneficial for network devices to determine its own settings based on the energy saving configurations of neighbor network devices.

The energy saving information comprises a set of energy saving configurations. For example, in some embodiments, the energy saving information may comprise a first list of energy saving configurations to add. The first list may comprise information of one or more energy saving configurations. In this case, when the first apparatus 210 receives this first list, the first apparatus 210 may add these energy saving configurations based on said information.

Alternatively or in addition, the energy saving information may comprise a second list of energy saving configurations to modify. This second list may contain information of one or more energy saving configurations. In this case, when the first apparatus 210 receives this second list, the first apparatus 210 may modify the information of these energy saving configurations based on the information.

In some other embodiments, the energy saving information may comprise a third list of energy saving configurations to delete. The third list may comprise information of one or more energy saving configurations. In this case, when the first apparatus 210 receives the third list, the first apparatus 210 may delete these energy saving configurations based on the information.

In some embodiments, an energy saving configuration in the set of energy saving configurations may comprise a first information element associated with an identity of the energy saving configuration. For example, in some embodiments, the first information element may comprise an energy saving index. Alternatively, the first information element may comprise an energy saving level. In some other embodiments, the first information element may comprise an energy consumption index. Alternatively, the first information element may comprise an energy consumption level. In some embodiments, the first information element associated with an identity of the energy saving configuration may be for one or more cells of the second apparatus 220 or for the second apparatus 220. The above mentioned index or level can be a proper integer number. For example, the second apparatus 220 may support N energy saving indices/levels (i.e., from energy saving index/level 0 to energy saving index/level N−1). In this case, in some embodiments, the index/level 0 may refer to that no energy saving schemes is applied (i.e., lowest energy saving level) and the index/level N−1 may refer to that the cell is deactivated (i.e., highest energy saving level); in other embodiments, the index/level N−1 may refer to that no energy saving schemes is applied (i.e., lowest energy saving level) and the index/level 0 may refer to that the cell is deactivated (i.e., highest energy saving level). The index/level 1 to index/level N−2 may refer to different energy saving levels between index/level 0 and index/level N−1. In some embodiments, the larger number of energy saving index/level means more energy can be saved. Alternatively, the smaller number of energy saving index/level means more energy can be saved.

Alternatively, the energy saving configuration may comprise a second information element associated with a percentage of energy saving of the energy saving configuration. The percentage of energy saving may be associated with the energy saving index/level. For example, 0% may refer to the lowest energy saving effect which may mean no energy saving scheme is applied. 100% may refer to the highest energy saving effect which may mean the cell is deactivated. A percentage of P % may mean P % of the energy can be saved relative to the highest energy consumption, where P is a number between 0 and 100. The determination of the percentage P % may be an implementation issue for the second apparatus 220, and may roughly reflect how much energy can be saved.

In some embodiments, the second information element may be associated with a percentage of energy consumption of the energy saving configuration. In this case, for example, 100% may refer to the energy consumption if no energy saving scheme is applied, and 0% may refer to the energy consumption if the cell is deactivated. The percentage of P % may mean P % of the energy can be consumed relative to the highest energy consumption, where P is a number between 0 and 100.

In some other embodiments, the energy saving configuration may comprise a third information element of a cell associated with the energy saving configuration. For example, the third information element may comprise a cell identity of the cell. Alternatively, the third information element may comprise an identity of the second apparatus 220 associated with the energy saving configuration. In this case, if the identity of the second apparatus 220 is indicated, it may mean that all cells owned by the second apparatus 220 are associated with the energy saving configuration.

Alternatively or in addition, the third information element may comprise frequency information of the cell. For example, the frequency information may comprise a subcarrier spacing (SCS) of the cell. The frequency information may also comprise a center frequency of the cell. In some embodiments, the third information element may comprise bandwidth information of the cell. For example, the bandwidth information may comprise the number of resource blocks (RBs) of the channel bandwidth of the cell. In some other embodiments, the third information element may comprise an antenna configuration of the cell. Only as an example, the antenna configuration may comprise the number of active antenna ports.

In some embodiments, the third information element may comprise a time domain resource configuration of the cell. For example, the time domain resource configuration may comprise a slot format configuration, e.g., a TDD-downlink-uplink configuration. Alternatively or in addition, the time domain resource configuration may comprise a duty cycle of the second apparatus 220. The time domain resource configuration may also indicate a percentage of available/unused time domain resources. Additionally, the time domain resource configuration may indicate a position of the available/unused time domain resources.

In some other embodiments, the third information element may comprise a synchronization signal/physical broadcast channel block (SSB) configuration of the cell. For example, the SSB configuration may comprise the number of SSBs in a burst. Alternatively or in addition, the SSB configuration may comprise SSB positions in a burst. The SSB configuration may also indicate a periodicity of SSB. In some embodiments, the SSB configuration may indication a frequency location of the SSB.

Alternatively or in addition, the third information element may comprise a physical random access channel (PRACH) configuration of the cell. For example, the PRACH configuration may comprise an index of the PRACH configuration. In some embodiments, the PRACH configuration may indicate PRACH time resources and/or frequency resources.

In some embodiments, the energy saving configuration may comprise at least one application condition of the energy saving configuration. The application condition can be interpreted as recommendation or assistant information from the second apparatus 220 to assist the first apparatus 210 to select the active energy saving configuration. As shown in FIG. 2, if one or more application conditions are satisfied, the first apparatus 210 may determine 2020 an active energy saving configuration with the one or more application conditions. The first apparatus 210 may determine apply the corresponding energy saving configuration associated with the one or more application conditions.

For example, in some embodiments, the application condition may comprise a resource condition for applying the energy saving configuration. Only as an example, the resource condition may be a range of percentage of resource usage. Alternatively, the resource condition may be a range of number of resource usage. The resource may refer to PRB or slot. For example, assuming 4 energy saving configurations are supported by the second apparatus 220, they may be associated with 4 resource conditions, e.g., below 30%, 30% to 50%, 50% to 80%, and above 80%, respectively. In this case, assuming the resource usage of a certain cell is 60%, the first apparatus 210 may select the energy saving configuration which is associated with the “50% to 80%” resource condition as the active energy saving configuration for this cell. Alternatively, the 4 resource conditions can also be 4 ranges of number, e.g., “below 50 PRBs”, “50 PRBs to 100 PRBs”, “100 PRBS to 150 PRBs”, and “above 150 PRBs”. In this case, assuming the resource usage of a certain cell is 60 PRBs, the first apparatus 210 may select the energy saving configuration which is associated with the “50 PRBs to 100 PRBs” resource condition as the active energy saving configuration for this cell.

Alternatively or in addition, the application condition may comprise a hardware condition for applying the energy saving configuration. For example, the hardware condition may be a range of percentage of hardware usage. By way of example, assuming 4 energy saving configurations are supported by the second apparatus 220, they may be associated with 4 hardware conditions, e.g., below 20%, 20% to 40%, 40% to 60%, and above 60%, respectively. In this case, assuming the hardware usage of a certain cell is 50%, the first apparatus 210 may select the energy saving configuration which is associated with the “40% to 60%” hardware condition as the active energy saving configuration for this cell.

In some other embodiments, the application condition may comprise a capacity condition for applying the energy saving configuration. For example, the capacity condition may be a range of percentage of the cell capacity. In this case, 100% may mean the maximum cell capacity. For example, assuming 4 energy saving configurations are supported by the second apparatus 220, they may be associated with 4 capacity conditions, e.g., below 30%, 30% to 50%, 50% to 80%, and above 80%, respectively. In this case, assuming the cell capacity of a certain cell is 60%, the first apparatus 210 may select the energy saving configuration which is associated with the “50% to 80%” capacity condition as the active energy saving configuration for this cell.

Alternatively or in addition, the application condition may comprise the number of active terminal devices for a cell or for the second apparatus 220. For example, 4 energy saving configurations may be associated with 4 range of the numbers of active UEs, e.g., below 20, 20 to 100, 100 to 200, above 200, the number can be a fractional number since it is an average value. In this case, assuming the number of active UEs of a certain cell is 150, the first apparatus 210 may select the energy saving configuration which is associated with the “100 to 200” active UEs as the active energy saving configuration for this cell.

In some embodiments, the energy saving configuration may comprise a performance information element of the cell when the energy saving configuration is applied. The performance information element may refer to expected cost or expected performance if the corresponding energy saving configuration is applied. The performance information element may be interpreted as recommendation or assistant information from the second apparatus 220 to assist the first apparatus 210 to select the active energy saving configuration. In some embodiments, the performance information element may comprise one or more performance metrics. Alternatively or in addition, the performance information element may comprise one or more performance degradation metrics.

For example, in some embodiments, the performance information element may comprise capacity information of the cell. For example, the capacity information may indicate a supported bit rate if the corresponding energy saving configuration is applied. Alliteratively, the capacity information may indicate how much capacity is lost relative to the full energy consumption case.

Alternatively or in addition, the performance information element may comprise coverage information of the cell. For example, the coverage information may indicate a supported coverage if the corresponding energy saving configuration is applied. The supported coverage may be an indication of whether the coverage is decreased or extended. Alternatively, the coverage information may indicate how much coverage is lost relative to the full energy consumption case.

In some other embodiments, the performance information element may comprise the number of active terminal devices in the cell. For example, the performance information element may indicate the supported number of active terminal devices if the corresponding energy saving configuration is applied. Alternatively, the performance information element may indicate how much the active terminal device number is lost relative to the full energy consumption case.

In some embodiments, the performance information element may comprise service type supported by the energy saving configuration. Alternatively or in addition, the performance information element may comprise service type not supported by the energy saving configuration. For example, the performance information element may indicate that for a first energy saving configuration, ultra-reliable low-latency (URLLC) or extended reality (XR) services are supported. Alternatively or in addition, the performance information element may indicate for a second energy saving configuration, URLLC or XR services are not supported.

The performance information element may also comprise a quality of service (QoS) parameter. For example, the performance information element may comprise supported value of QoS parameters. Alternatively or in addition, the performance information element may comprise not supported value of QoS parameters. In some embodiments, the QoS parameter may comprise one or more of: 5G QoS identifier (5QI) value, a resource type (for example, guaranteed bit rate (GBR) or non-GBR), a priority level, a packet delay budget, a packet error rate or a maximum date burst volume. It should be noted that the energy saving configuration may comprise other information associated with the energy saving.

In some embodiments, the second apparatus 220 may transmit a measurement result to the first apparatus 210. In this case, the first apparatus 210 may determine or trigger the active energy saving configuration based on the measurement. In some embodiments, the measurement result may indicate load of the second apparatus 220. Alternatively, the measurement result may indicate the resource usage of the second apparatus 220. In some other embodiments, the measurement result may indicate the number of active terminal devices connected to the second apparatus 220. It should be noted that the measurement result may also comprise other results.

The first apparatus 210 transmits 2030 an indication of the active energy saving configuration to the second apparatus 220. For example, the first apparatus 210 may transmit an energy saving update message to the second apparatus 220, which may include the indication of the active energy saving configuration.

In some embodiments, if the active energy saving configuration is different from the current energy saving configuration, the second apparatus 220 may activate 2040 the active energy saving configuration and deactivate the current energy saving configuration. Alternatively, if the active energy saving configuration is same as the current energy saving configuration, the second apparatus 220 may update the configuration of the current energy saving configuration to align with the parameters indicated by the active energy saving configuration.

The second apparatus 220 may transmit 2050 a feedback message to the first apparatus 210. The feedback message may indicate whether the active energy saving configuration is activated at the second apparatus 220. For example, the second apparatus 220 may send an energy saving update acknowledge message to the first apparatus 210 to indicate the activation of the active energy saving configuration is successful. Alternatively, the second apparatus 220 may send an energy saving update failure message to the first apparatus 210 to indicate the activation of the active energy saving configuration is failure. Additionally, the reason of the failure (e.g., not supported parameters, not enough hardware resource, and the like) can also be indicated in this energy saving update failure message. In this way, the active energy saving configuration may be determined more accurately.

In some embodiments, the second apparatus 220 may transmit an energy saving update request message to the first apparatus 210. This energy saving update request message may include a request to activate an energy saving configuration. The energy saving update request message may comprise one or more candidate energy saving configurations. The first apparatus 210 may send an energy saving update response message to the second apparatus 220. In some embodiments, if the energy saving update request message comprises more than one candidate energy saving configuration, the first apparatus 210 may determine the active energy saving configuration from the more than one candidate energy saving configuration.

In some embodiments, if the response message includes an indication of active energy saving configuration and the active energy saving configuration is different from the current energy saving configuration, the second apparatus 220 may activate the active energy saving configuration and deactivate the current energy saving configuration. Alternatively, if the response message includes an indication of active energy saving configuration and the active energy saving configuration is same as the current energy saving configuration, the second apparatus 220 may update the current energy saving configuration based on the response message. In some other embodiments, if the response message does not indicate an active energy saving configuration or the second apparatus 220 does not receive an energy saving update response, the second apparatus 220 may still use the current energy saving configuration. In this way, since the power hungry modules are mainly located at gNB-DU, and gNB-DU may also have the original measurement data for a cell, it is reasonable to let gNB-DU to trigger an energy saving configuration switching to a gNB-CU.

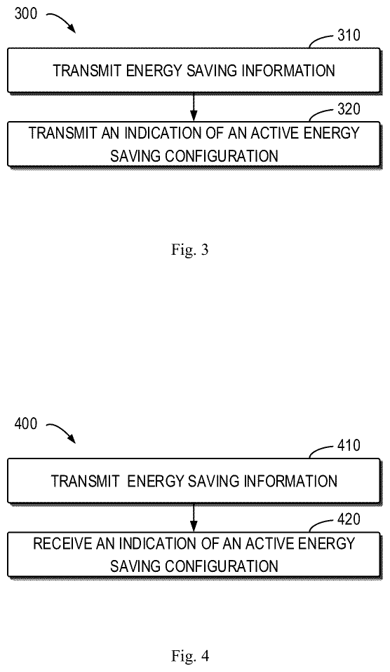

FIG. 3 shows a flowchart of an example method 300 in accordance with an embodiment of the present disclosure. The method 300 can be implemented at a first apparatus. Only for the purpose of illustrations, in some embodiments, the method 300 can be implemented at the gNB-CU 120 as shown in FIG. 1. Alternatively, the method 300 can be implemented at the gNB 110-1 as shown in FIG. 1.

At block 310, the first apparatus receives energy saving information from the second apparatus. In some embodiments, the energy saving information may be transmitted using an energy saving information procedure. Alternatively, in some embodiments, if the first apparatus is the gNB-CU 120 and the second apparatus is the gNB-DU 130-1, the energy saving information may be included in a gNB-DU configuration update message which may be transmitted from the gNB-DU 130-1 to the gNB-CU 120. In this case, the gNB-DU configuration update message may also comprise one or more of a cells-to-be-activated-list item information element (IE) or a cells-to-be-deactivated-list item IE. In this way, if the first apparatus is a gNB-CU and the second apparatus is a gNB-DU, a gNB-DU can have multiple energy saving levels with different settings, which is beneficial to get balance between energy saving and performance. Moreover, it is beneficial for the interoperation between the gNB-CU and the gNB-DU, especially for the inter-vendor cases. The gNB-CU can be aware of the energy saving capability of a gNB-DU as well as the application condition and the expected energy saving level. Then gNB-CU can make decisions to activate/deactivate an energy saving configuration when necessary. In another situation where both the first apparatus and the second apparatus are network devices, since there may be a header network device to coordinate the energy saving settings among a group of network devices, it is beneficial to allow network devices exchange the information of energy saving settings. Moreover, since the energy saving configurations may have impact on the coverage, performance and interference, it is beneficial for network devices to determine its own settings based on the energy saving configurations of neighbor network devices.

The energy saving information comprises a set of energy saving configurations. For example, in some embodiments, the energy saving information may comprise a first list of energy saving configurations to add. The first list may comprise information of one or more energy saving configurations. In this case, when the first apparatus receives this first list, the first apparatus may add these energy saving configurations based on said information.

Alternatively or in addition, the energy saving information may comprise a second list of energy saving configurations to modify. This second list may contain information of one or more energy saving configurations. In this case, when the first apparatus receives this second list, the first apparatus may modify the information of these energy saving configurations based on the information.

In some other embodiments, the energy saving information may comprise a third list of energy saving configurations to delete. The third list may comprise information of one or more energy saving configurations. In this case, when the first apparatus receives the third list, the first apparatus may delete these energy saving configurations based on the information.

In some embodiments, an energy saving configuration in the set of energy saving configurations may comprise a first information element associated with an identity of the energy saving configuration. For example, in some embodiments, the first information element may comprise an energy saving index. Alternatively, the first information element may comprise an energy saving level. In some other embodiments, the first information element may comprise an energy consumption index. Alternatively, the first information element may comprise an energy consumption level. In some embodiments, the first information element associated with an identity of the energy saving configuration may be for one or more cells of the second apparatus or for the second apparatus. The above mentioned index or level can be a proper integer number. For example, the second apparatus may support N energy saving indices/levels (i.e., from energy saving index/level 0 to energy saving index/level N−1). In this case, in some embodiments, the index/level 0 may refer to that no energy saving schemes is applied (i.e., lowest energy saving level) and the index/level N−1 may refer to that the cell is deactivated (i.e., highest energy saving level); in other embodiments, the index/level N−1 may refer to that no energy saving schemes is applied (i.e., lowest energy saving level) and the index/level 0 may refer to that the cell is deactivated (i.e., highest energy saving level). The index/level 1 to index/level N−2 may refer to different energy saving levels between index/level 0 and index/level N−1. In some embodiments, the larger number of energy saving index/level means more energy can be saved. Alternatively, the smaller number of energy saving index/level means more energy can be saved.

Alternatively, the energy saving configuration may comprise a second information element associated with a percentage of energy saving of the energy saving configuration. The percentage of energy saving may be associated with the energy saving index/level. For example, 0% may refer to the lowest energy saving effect which may mean no energy saving scheme is applied. 100% may refer to the highest energy saving effect which may mean the cell is deactivated. A percentage of P % may mean P % of the energy can be saved relative to the highest energy consumption, where P is a number between 0 and 100. The determination of the percentage P % may be an implementation issue for the second apparatus 220, and may roughly reflect how much energy can be saved.

In some embodiments, the second information element may be associated with a percentage of energy consumption of the energy saving configuration. In this case, for example, 100% may refer to the energy consumption if no energy saving scheme is applied, and 0% may refer to the energy consumption if the cell is deactivated. The percentage of P % may mean P % of the energy can be consumed relative to the highest energy consumption, where P is a number between 0 and 100.

In some other embodiments, the energy saving configuration may comprise a third information element of a cell associated with the energy saving configuration. For example, the third information element may comprise a cell identity of the cell. Alternatively, the third information element may comprise an identity of the second apparatus associated with the energy saving configuration. In this case, if the identity of the second apparatus is indicated, it may mean that all cells owned by the second apparatus are associated with the energy saving configuration.

Alternatively or in addition, the third information element may comprise frequency information of the cell. For example, the frequency information may comprise a subcarrier spacing (SCS) of the cell. The frequency information may also comprise a center frequency of the cell. In some embodiments, the third information element may comprise bandwidth information of the cell. For example, the bandwidth information may comprise the number of resource blocks (RBs) of the channel bandwidth of the cell. In some other embodiments, the third information element may comprise an antenna configuration of the cell. Only as an example, the antenna configuration may comprise the number of active antenna ports.

In some embodiments, the third information element may comprise a time domain resource configuration of the cell. For example, the time domain resource configuration may comprise a slot format configuration, e.g., a TDD-downlink-uplink configuration. Alternatively or in addition, the time domain resource configuration may comprise a duty cycle of the second apparatus. The time domain resource configuration may also indicate a percentage of available/unused time domain resources. Additionally, the time domain resource configuration may indicate a position of the available/unused time domain resources.

In some other embodiments, the third information element may comprise a synchronization signal/physical broadcast channel block (SSB) configuration of the cell. For example, the SSB configuration may comprise the number of SSBs in a burst. Alternatively or in addition, the SSB configuration may comprise SSB positions in a burst. The SSB configuration may also indicate a periodicity of SSB. In some embodiments, the SSB configuration may indication a frequency location of the SSB.

Alternatively or in addition, the third information element may comprise a physical random access channel (PRACH) configuration of the cell. For example, the PRACH configuration may comprise an index of the PRACH configuration. In some embodiments, the PRACH configuration may indicate PRACH time resources and/or frequency resources.

In some embodiments, the energy saving configuration may comprise at least one application condition of the energy saving configuration. The application condition can be interpreted as recommendation or assistant information from the second apparatus to assist the first apparatus to select the active energy saving configuration.

In some embodiments, if one or more application conditions are satisfied, the first apparatus may determine an active energy saving configuration with the one or more application conditions. The first apparatus may determine apply the corresponding energy saving configuration associated with the one or more application conditions.

For example, in some embodiments, the application condition may comprise a resource condition for applying the energy saving configuration. Only as an example, the resource condition may be a range of percentage of resource usage. Alternatively, the resource condition may be a range of number of resource usage. The resource may refer to PRB or slot. For example, assuming 4 energy saving configurations are supported by the second apparatus, they may be associated with 4 resource conditions, e.g., below 30%, 30% to 50%, 50% to 80%, and above 80%, respectively. In this case, assuming the resource usage of a certain cell is 60%, the first apparatus may select the energy saving configuration which is associated with the “50% to 80%” resource condition as the active energy saving configuration for this cell. Alternatively, the 4 resource conditions can also be 4 ranges of number, e.g., “below 50 PRBs”, “50 PRBs to 100 PRBs”, “100 PRBS to 150 PRBs”, and above “150 PRBs”. In this case, assuming the resource usage of a certain cell is 60 PRBs, the first apparatus may select the energy saving configuration which is associated with the “50 PRBs to 100 PRBs” resource condition as the active energy saving configuration for this cell.

Alternatively or in addition, the application condition may comprise a hardware condition for applying the energy saving configuration. For example, the hardware condition may be a range of percentage of hardware usage. Only as an example, assuming 4 energy saving configurations are supported by the second apparatus, they may be associated with 4 hardware conditions, e.g., below 20%, 20% to 40%, 40% to 60%, and above 60%, respectively. In this case, assuming the hardware usage of a certain cell is 50%, the first apparatus may select the energy saving configuration which is associated with the “40% to 60%” hardware condition as the active energy saving configuration for this cell.

In some other embodiments, the application condition may comprise a capacity condition for applying the energy saving configuration. For example, the capacity condition may be a range of percentage of the cell capacity. In this case, 100% may mean the maximum cell capacity. For example, assuming 4 energy saving configurations are supported by the second apparatus, they may be associated with 4 capacity conditions, e.g., below 30%, 30% to 50%, 50% to 80%, and above 80%, respectively. In this case, assuming the cell capacity of a certain cell is 60%, the first apparatus may select the energy saving configuration which is associated with the “50% to 80%” capacity condition as the active energy saving configuration for this cell.

Alternatively or in addition, the application condition may comprise the number of active terminal devices for a cell or for the second apparatus. For example, 4 energy saving configurations may be associated with 4 range of the numbers of active UEs, e.g., below 20, 20 to 100, 100 to 200, above 200, the number can be a fractional number since it is an average value. In this case, assuming the number of active UEs of a certain cell is 150, the first apparatus may select the energy saving configuration which is associated with the “100 to 200” active UEs as the active energy saving configuration for this cell.

In some embodiments, the energy saving configuration may comprise a performance information element of the cell when the energy saving configuration is applied. The performance information element may refer to expected cost or expected performance if the corresponding energy saving configuration is applied. The performance information element may be interpreted as recommendation or assistant information from the second apparatus to assist the first apparatus to select the active energy saving configuration. In some embodiments, the performance information element may comprise one or more performance metrics. Alternatively or in addition, the performance information element may comprise one or more performance degradation metrics.

For example, in some embodiments, the performance information element may comprise capacity information of the cell. For example, the capacity information may indicate a supported bit rate if the corresponding energy saving configuration is applied. Alliteratively, the capacity information may indicate how much capacity is lost relative to the full energy consumption case.

Alternatively or in addition, the performance information element may comprise coverage information of the cell. For example, the coverage information may indicate a supported coverage if the corresponding energy saving configuration is applied. The supported coverage may be an indication of whether the coverage is decreased or extended. Alternatively, the coverage information may indicate how much coverage is lost relative to the full energy consumption case.

In some other embodiments, the performance information element may comprise the number of active terminal devices in the cell. For example, the performance information element may indicate the supported number of active terminal devices if the corresponding energy saving configuration is applied. Alternatively, the performance information element may indicate how much the active terminal device number is lost relative to the full energy consumption case.

In some embodiments, the performance information element may comprise service type supported by the energy saving configuration. Alternatively or in addition, the performance information element may comprise service type not supported by the energy saving configuration. For example, the performance information element may indicate that for a first energy saving configuration, ultra-reliable low-latency (URLLC) or extended reality (XR) services are supported. Alternatively or in addition, the performance information element may indicate that for a second energy saving configuration, URLLC or XR services are not supported.

The performance information element may also comprise a quality of service (QoS) parameter. For example, the performance information element may comprise supported value of QoS parameters. Alternatively or in addition, the performance information element may comprise not supported value of QoS parameters. In some embodiments, the QoS parameter may comprise one or more of: 5G QoS identifier (5QI) value, a resource type (for example, guaranteed bit rate (GBR) or non-GBR), a priority level, a packet delay budget, a packet error rate or a maximum date burst volume. It should be noted that the energy saving configuration may comprise other information associated with the energy saving.

In some embodiments, the second apparatus may transmit a measurement result to the first apparatus. In this case, the first apparatus may determine or trigger the active energy saving configuration based on the measurement. In some embodiments, the measurement result may indicate load of the second apparatus. Alternatively, the measurement result may indicate the resource usage of the second apparatus. In some other embodiments, the measurement result may indicate the number of active terminal devices connected to the second apparatus. It should be noted that the measurement result may also comprise other results.

At block 320, the first apparatus transmits an indication of the active energy saving configuration to the second apparatus. For example, the first apparatus may transmit an energy saving update message to the second apparatus, which may include the indication of the active energy saving configuration.

In some embodiments, the first apparatus may receive a feedback message from the second apparatus. The feedback message may indicate whether the active energy saving configuration is activated at the second apparatus. For example, the second apparatus may send an energy saving update acknowledge message to the first apparatus to indicate the activation of the active energy saving configuration is successful. Alternatively, the second apparatus may send an energy saving update failure message to the first apparatus to indicate the activation of the active energy saving configuration is failure. Additionally, the reason of the failure (e.g., not supported parameters, not enough hardware resource, and the like) can also be indicated in this energy saving update failure message. In this way, the active energy saving configuration may be determined more accurately.

In some embodiments, the first apparatus may receive an energy saving update request message from the second apparatus. This energy saving update request message may include a request to activate an energy saving configuration. The energy saving update request message may comprise one or more candidate energy saving configurations. The first apparatus may send an energy saving update response message to the second apparatus. In some embodiments, if the energy saving update request message comprises more than one candidate energy saving configuration, the first apparatus may determine the active energy saving configuration from the more than one candidate energy saving configuration.

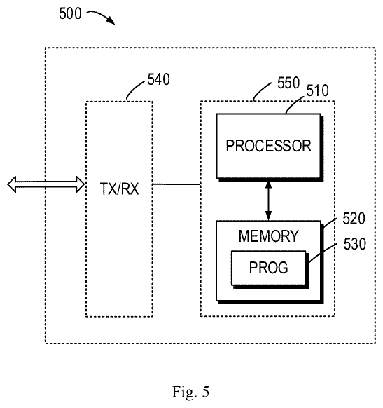

FIG. 4 shows a flowchart of an example method 400 in accordance with an embodiment of the present disclosure. The method 400 can be implemented at any suitable devices. Only for the purpose of illustrations, in some embodiments, the method 300 can be implemented at the gNB-DU 130-1 or 130-2 as shown in FIG. 1. Alternatively, the method 300 can be implemented at the gNB 110-2 as shown in FIG. 1.

At block 410, the second apparatus transmits energy saving information to the first apparatus. In some embodiments, the energy saving information may be transmitted using an energy saving information procedure. Alternatively, in some embodiments, if the first apparatus is the gNB-CU 120 and the second apparatus is the gNB-DU 130-1, the energy saving information may be included in a gNB-DU configuration update message which may be transmitted from the gNB-DU 130-1 to the gNB-CU 120. In this case, the gNB-DU configuration update message may also comprise one or more of: a cells-to-be-activated-list item information element (IE) or a cells-to-be-deactivated-list item IE. In this way, if the first apparatus is a gNB-CU and the second apparatus 220 is a gNB-DU, a gNB-DU can have multiple energy saving levels with different settings, which is beneficial to get balance between energy saving and performance. Moreover, it is beneficial for the interoperation between the gNB-CU and the gNB-DU, especially for the inter-vendor cases. The gNB-CU can be aware of the energy saving capability of a gNB-DU as well as the application condition and the expected energy saving level. Then gNB-CU can make decisions to activate/deactivate an energy saving configuration when necessary. In another situation where both the first apparatus and the second apparatus are network devices, since there may be a header network device to coordinate the energy saving settings among a group of network devices, it is beneficial to allow network devices exchange the information of energy saving settings. Moreover, since the energy saving configurations may have impact on the coverage, performance and interference, it is beneficial for network devices to determine its own settings based on the energy saving configurations of neighbor network devices.

The energy saving information comprises a set of energy saving configurations. For example, in some embodiments, the energy saving information may comprise a first list of energy saving configurations to add. The first list may comprise information of one or more energy saving configurations. In this case, when the first apparatus receives this first list, the first apparatus may add these energy saving configurations based on said information.

Alternatively or in addition, the energy saving information may comprise a second list of energy saving configurations to modify. This second list may contain information of one or more energy saving configurations. In this case, when the first apparatus receives this second list, the first apparatus may modify the information of these energy saving configurations based on the information.

In some other embodiments, the energy saving information may comprise a third list of energy saving configurations to delete. The third list may comprise information of one or more energy saving configurations. In this case, when the first apparatus receives the third list, the first apparatus may delete these energy saving configurations based on the information.

In some embodiments, an energy saving configuration in the set of energy saving configurations may comprise a first information element associated with an identity of the energy saving configuration. For example, in some embodiments, the first information element may comprise an energy saving index. Alternatively, the first information element may comprise an energy saving level. In some other embodiments, the first information element may comprise an energy consumption index. Alternatively, the first information element may comprise an energy consumption level. In some embodiments, the first information element associated with an identity of the energy saving configuration may be for one or more cells of the second apparatus or for the second apparatus. The above mentioned index or level can be a proper integer number. For example, the second apparatus may support N energy saving indices/levels (i.e., from energy saving index/level 0 to energy saving index/level N−1). In this case, in some embodiments, the index/level 0 may refer to that no energy saving schemes is applied (i.e., lowest energy saving level) and the index/level N−1 may refer to that the cell is deactivated (i.e., highest energy saving level); in other embodiments, the index/level N−1 may refer to that no energy saving schemes is applied (i.e., lowest energy saving level) and the index/level 0 may refer to that the cell is deactivated (i.e., highest energy saving level). The index/level 1 to index/level N−2 may refer to different energy saving levels between index/level 0 and index/level N−1. In some embodiments, the larger number of energy saving index/level means more energy can be saved. Alternatively, the smaller number of energy saving index/level means more energy can be saved.

Alternatively, the energy saving configuration may comprise a second information element associated with a percentage of energy saving of the energy saving configuration. The percentage of energy saving may be associated with the energy saving index/level. For example, 0% may refer to the lowest energy saving effect which may mean no energy saving scheme is applied. 100% may refer to the highest energy saving effect which may mean the cell is deactivated. A percentage of P % may mean P % of the energy can be saved relative to the highest energy consumption, where P is a number between 0 and 100. The determination of the percentage P % may be an implementation issue for the second apparatus 220, and may roughly reflect how much energy can be saved.

In some embodiments, the second information element may be associated with a percentage of energy consumption of the energy saving configuration. In this case, for example, 100% may refer to the energy consumption if no energy saving scheme is applied, and 0% may refer to the energy consumption if the cell is deactivated. The percentage of P % may mean P % of the energy can be consumed relative to the highest energy consumption, where P is a number between 0 and 100.

In some other embodiments, the energy saving configuration may comprise a third information element of a cell associated with the energy saving configuration. For example, the third information element may comprise a cell identity of the cell. Alternatively, the third information element may comprise an identity of the second apparatus associated with the energy saving configuration. In this case, if the identity of the second apparatus is indicated, it may mean that all cells owned by the second apparatus are associated with the energy saving configuration.

Alternatively or in addition, the third information element may comprise frequency information of the cell. For example, the frequency information may comprise a subcarrier spacing (SCS) of the cell. The frequency information may also comprise a center frequency of the cell. In some embodiments, the third information element may comprise bandwidth information of the cell. For example, the bandwidth information may comprise the number of resource blocks (RBs) of the channel bandwidth of the cell. In some other embodiments, the third information element may comprise an antenna configuration of the cell. Only as an example, the antenna configuration may comprise the number of active antenna ports.

In some embodiments, the third information element may comprise a time domain resource configuration of the cell. For example, the time domain resource configuration may comprise a slot format configuration, e.g., a TDD-downlink-uplink configuration. Alternatively or in addition, the time domain resource configuration may comprise a duty cycle of the second apparatus. The time domain resource configuration may also indicate a percentage of available/unused time domain resources. Additionally, the time domain resource configuration may indicate a position of the available/unused time domain resources.

In some other embodiments, the third information element may comprise a synchronization signal/physical broadcast channel block (SSB) configuration of the cell. For example, the SSB configuration may comprise the number of SSBs in a burst. Alternatively or in addition, the SSB configuration may comprise SSB positions in a burst. The SSB configuration may also indicate a periodicity of SSB. In some embodiments, the SSB configuration may indication a frequency location of the SSB.

Alternatively or in addition, the third information element may comprise a physical random access channel (PRACH) configuration of the cell. For example, the PRACH configuration may comprise an index of the PRACH configuration. In some embodiments, the PRACH configuration may indicate PRACH time resources and/or frequency resources.

In some embodiments, the energy saving configuration may comprise at least one application condition of the energy saving configuration. The application condition can be interpreted as recommendation or assistant information from the second apparatus to assist the first apparatus to select the active energy saving configuration.

For example, in some embodiments, the application condition may comprise a resource condition for applying the energy saving configuration. Only as an example, the resource condition may be a range of percentage of resource usage. Alternatively, the resource condition may be a range of number of resource usage. The resource may refer to PRB or slot. For example, assuming 4 energy saving configurations are supported by the second apparatus, they may be associated with 4 resource conditions, e.g., below 30%, 30% to 50%, 50% to 80%, and above 80%, respectively. In this case, assuming the resource usage of a certain cell is 60%, the first apparatus may select the energy saving configuration which is associated with the “50% to 80%” resource condition as the active energy saving configuration for this cell. Alternatively, the 4 resource conditions can also be 4 ranges of number, e.g., “below 50 PRBs”, “50 PRBs to 100 PRBs”, “100 PRBS to 150 PRBs”, and above “150 PRBs”. In this case, assuming the resource usage of a certain cell is 60, the first apparatus may select the energy saving configuration which is associated with the “50 PRBs to 100 PRBs” resource condition as the active energy saving configuration for this cell.

Alternatively or in addition, the application condition may comprise a hardware condition for applying the energy saving configuration. For example, the hardware condition may be a range of percentage of hardware usage. Only as an example, assuming 4 energy saving configurations are supported by the second apparatus, they may be associated with 4 hardware conditions, e.g., below 20%, 20% to 40%, 40% to 60%, and above 60%, respectively. In this case, assuming the hardware usage of a certain cell is 50%, the first apparatus may select the energy saving configuration which is associated with the “40% to 60%” hardware condition as the active energy saving configuration for this cell.

In some other embodiments, the application condition may comprise a capacity condition for applying the energy saving configuration. For example, the capacity condition may be a range of percentage of the cell capacity. In this case, 100% may mean the maximum cell capacity. For example, assuming 4 energy saving configurations are supported by the second apparatus, they may be associated with 4 capacity conditions, e.g., below 30%, 30% to 50%, 50% to 80%, and above 80%, respectively. In this case, assuming the cell capacity of a certain cell is 60%, the first apparatus may select the energy saving configuration which is associated with the “50% to 80%” capacity condition as the active energy saving configuration for this cell.

Alternatively or in addition, the application condition may comprise the number of active terminal devices for a cell or for the second apparatus. For example, 4 energy saving configurations may be associated with 4 range of the numbers of active UEs, e.g., below 20, 20 to 100, 100 to 200, above 200, the number can be a fractional number since it is an average value. In this case, assuming the number of active UEs of a certain cell is 150, the first apparatus may select the energy saving configuration which is associated with the “100 to 200” active UEs as the active energy saving configuration for this cell.

In some embodiments, the energy saving configuration may comprise a performance information element of the cell when the energy saving configuration is applied. The performance information element may refer to expected cost or expected performance if the corresponding energy saving configuration is applied. The performance information element may be interpreted as recommendation or assistant information from the second apparatus to assist the first apparatus to select the active energy saving configuration. In some embodiments, the performance information element may comprise one or more performance metrics. Alternatively or in addition, the performance information element may comprise one or more performance degradation metrics.

For example, in some embodiments, the performance information element may comprise capacity information of the cell. For example, the capacity information may indicate a supported bit rate if the corresponding energy saving configuration is applied. Alliteratively, the capacity information may indicate how much capacity is lost relative to the full energy consumption case.

Alternatively or in addition, the performance information element may comprise coverage information of the cell. For example, the coverage information may indicate a supported coverage if the corresponding energy saving configuration is applied. The supported coverage may be an indication of whether the coverage is decreased or extended. Alternatively, the coverage information may indicate how much coverage is lost relative to the full energy consumption case.

In some other embodiments, the performance information element may comprise the number of active terminal devices in the cell. For example, the performance information element may indicate the supported number of active terminal devices if the corresponding energy saving configuration is applied. Alternatively, the performance information element may indicate how much the active terminal device number is lost relative to the full energy consumption case.

In some embodiments, the performance information element may comprise service type supported by the energy saving configuration. Alternatively or in addition, the performance information element may comprise service type not supported by the energy saving configuration. For example, the performance information element may indicate that for a first energy saving configuration, ultra-reliable low-latency (URLLC) or extended reality (XR) services are supported. Alternatively or in addition, the performance information element may indicate for a second energy saving configuration, URLLC or XR services are not supported.

The performance information element may also comprise a quality of service (QoS) parameter. For example, the performance information element may comprise supported value of QoS parameters. Alternatively or in addition, the performance information element may comprise not supported value of QoS parameters. In some embodiments, the QoS parameter may comprise one or more of: 5G QoS identifier (5QI) value, a resource type (for example, guaranteed bit rate (GBR) or non-GBR), a priority level, a packet delay budget, a packet error rate or a maximum date burst volume. It should be noted that the energy saving configuration may comprise other information associated with the energy saving.

In some embodiments, the second apparatus may transmit a measurement result to the first apparatus. In this case, the first apparatus may determine or trigger the active energy saving configuration based on the measurement. In some embodiments, the measurement result may indicate load of the second apparatus. Alternatively, the measurement result may indicate the resource usage of the second apparatus. In some other embodiments, the measurement result may indicate the number of active terminal devices connected to the second apparatus. It should be noted that the measurement result may also comprise other results.

At block 420, the second apparatus receives an indication of the active energy saving configuration from the first apparatus. For example, the first apparatus may transmit an energy saving update message to the second apparatus, which may include the indication of the active energy saving configuration.

In some embodiments, if the active energy saving configuration is different from the current energy saving configuration, the second apparatus may activate the active energy saving configuration and deactivate the current energy saving configuration. Alternatively, if the active energy saving configuration is same as the current energy saving configuration, the second apparatus may update the configuration of the current energy saving configuration to align with the parameters indicated by the active energy saving configuration.

The second apparatus may transmit a feedback message to the first apparatus. The feedback message may indicate whether the active energy saving configuration is activated at the second apparatus. For example, the second apparatus may send an energy saving update acknowledge message to the first apparatus to indicate the activation of the active energy saving configuration is successful. Alternatively, the second apparatus may send an energy saving update failure message to the first apparatus to indicate the activation of the active energy saving configuration is failure. Additionally, the reason of the failure (e.g., not supported parameters, not enough hardware resource, and the like) can also be indicated in this energy saving update failure message. In this way, the active energy saving configuration may be determined more accurately.

In some embodiments, the second apparatus may transmit an energy saving update request message to the first apparatus. This energy saving update request message may include a request to activate an energy saving configuration. The energy saving update request message may comprise one or more candidate energy saving configurations. The second apparatus may receive an energy saving update response message from the first apparatus. In some embodiments, if the energy saving update request message comprises more than one candidate energy saving configuration, the first apparatus may determine the active energy saving configuration from the more than one candidate energy saving configuration.

In some embodiments, if the response message includes an indication of active energy saving configuration and the active energy saving configuration is different from the current energy saving configuration, the second apparatus may activate the active energy saving configuration and deactivate the current energy saving configuration. Alternatively, if the response message includes an indication of active energy saving configuration and the active energy saving configuration is same as the current energy saving configuration, the second apparatus may update the current energy saving configuration based on the response message. In some other embodiments, if the response message does not indicate an active energy saving configuration or the second apparatus does not receive an energy saving update response, the second apparatus may still use the current energy saving configuration. In this way, since the power hungry modules are mainly located at gNB-DU, and gNB-DU may also have the original measurement data for a cell, it is reasonable to let gNB-DU to trigger an energy saving configuration switching to a gNB-CU.

It should be noted that embodiments described with reference to FIGS. 2-4 can be implemented separately or together.

In some embodiments, an apparatus comprises circuitry configured to perform: receiving, at a centralized unit (CU) of a network device, energy saving information from a distributed unit (DU) of the network device, the energy saving information comprising a set of energy saving configurations, and an energy saving configuration in the set of energy saving configurations indicating at least one of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied; and transmitting, to the DU, an indication of an active energy saving configuration from the set energy saving configurations, wherein the active energy saving configuration is to be activated for at least one cell.

In some embodiments, the set of energy saving configurations comprises at least one of: a list of energy saving configurations to add, a list of energy saving configurations to modify, or a list of energy saving configurations to delete.

In some embodiments, the first information element comprises one of: an energy saving index, an energy saving level, an energy consumption index, or an energy consumption level.

In some embodiments, the third information element comprises at least one of: a cell identity of the at least one cell, an identity of the DU associated with the energy saving configuration, frequency information of the at least one cell, bandwidth information of the at least one cell, an antenna configuration of the at least one cell, a time domain resource configuration of the at least one cell, a synchronization signal/physical broadcast channel block (SSB) configuration of the at least one cell, or a physical random access channel (PRACH) configuration of the at least one cell.

In some embodiments, the at least one application condition comprises at least one of: a resource condition for applying the energy saving configuration, a hardware condition for applying the energy saving configuration, a capacity condition for applying the energy saving configuration, or the number of active terminal devices.

In some embodiments, the apparatus comprises circuitry configured to perform: in accordance with a determination that one or more application conditions of the at least one application condition are satisfied, determining a target energy saving configuration associated with the at least one condition as the active energy saving configuration.

In some embodiments, the performance information element of the at least one cell comprises at least one of: capacity information of the at least one cell, coverage information of the at least one cell, the number of active terminal devices in the at least one cell, service type supported by the energy saving configuration, service type not supported by the energy saving configuration, or a quality of service parameter.

In some embodiments, the apparatus comprises circuitry configured to perform: determining the active energy saving configuration from the set of energy saving configurations based on the performance information elements associated with the energy saving configurations in the set of energy saving configurations.

In some embodiments, the apparatus comprises circuitry configured to perform: receiving, from the DU, a measurement result of the DU; and determining the active energy saving configuration in the set of energy saving configurations based on the measurement result.

In some embodiments, the apparatus comprises circuitry configured to perform: receiving, from the DU, a feedback message of the indication, the feedback message indicating whether the active energy saving configuration is activated at the DU.

In some embodiments, the apparatus comprises circuitry configured to perform: receiving an energy saving update request from the DU, the energy saving update request indicating at least one candidate energy saving configuration; and transmitting an energy saving update response to the DU.

In some embodiments, an apparatus comprises circuitry configured to perform: transmitting, at a distributed unit (DU) of a network device, energy saving information to a centralized unit (CU) of the network device, the energy saving information comprising a set of energy saving configurations, and an energy saving configuration in the set of energy saving configurations indicating at least one of: a first information element associated with an identity of the energy saving configuration, a second information element associated with a percentage of energy saving of the energy saving configuration, a third information element of at least one cell associated with the energy saving configuration, at least one application condition of the energy saving configuration, or a performance information element of the at least one cell when the energy saving configuration is applied; and receiving, from the CU, an indication of an active energy saving configuration from the set energy saving configurations, wherein the active energy saving configuration is to be activated for at least one cell.

In some embodiments, the set of energy saving configurations comprises at least one of: a list of energy saving configurations to add, a list of energy saving configurations to modify, or a list of energy saving configurations to delete.

In some embodiments, the first information element comprises one of: an energy saving index, an energy saving level, an energy consumption index, or an energy consumption level.

In some embodiments, the third information element comprises at least one of: a cell identity of the at least one cell, an identity of the DU associated with the energy saving configuration, frequency information of the at least one cell, bandwidth information of the at least one cell, an antenna configuration of the at least one cell, a time domain resource configuration of the at least one cell, a synchronization signal/physical broadcast channel block (SSB) configuration of the at least one cell, or a physical random access channel (PRACH) configuration of the at least one cell.

In some embodiments, the at least one application condition comprises at least one of: a resource condition for applying the energy saving configuration, a hardware condition for applying the energy saving configuration, a capacity condition for applying the energy saving configuration, or the number of active terminal devices.

In some embodiments, the performance information of the at least one cell comprises at least one of: capacity information of the at least one cell, coverage information of the at least one cell, the number of active terminal devices in the at least one cell, service type supported by the energy saving configuration, service type not supported by the energy saving configuration, or a quality of service parameter.

In some embodiments, the apparatus comprises circuitry configured to perform: transmitting, to the CU, a measurement result of the DU.

In some embodiments, the apparatus comprises circuitry configured to perform: in accordance with a determination that the active energy saving configuration is different from a current energy saving configuration, activating the active energy saving configuration; or in accordance with a determination that the active energy saving configuration is different from the current energy saving configuration, updating the current energy saving configuration.

In some embodiments, the apparatus comprises circuitry configured to perform: transmitting, to the CU, a feedback message of the indication, the feedback message indicating whether the active energy saving configuration is activated at the DU.

In some embodiments, the apparatus comprises circuitry configured to perform: transmitting an energy saving update request to the CU, the energy saving update request indicating at least one candidate energy saving configuration; and receiving an energy saving update response from the CU.

FIG. 5 is a simplified block diagram of a device 500 that is suitable for implementing embodiments of the present disclosure. The device 500 can be considered as a further example implementation of the network devices 110-1 or 110-2 as shown in FIG. 1. Accordingly, the device 500 can be implemented at or as at least a part of the network devices 110-1 or 110-2.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 520 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 530 is assumed to include program instructions that, when executed by the associated processor 510, enable the device 500 to operate in accordance with the embodiments of the present disclosure, as discussed herein with reference to FIG. 2 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 520 is shown in the device 1200, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space bome vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

I/We claim:

1. A communication method, comprising:
receiving, at a centralized unit (CU) of a network device, energy saving information from a distributed unit (DU) of the network device, the energy saving information comprising a set of energy saving configurations, and an energy saving configuration in the set of energy saving configurations indicating at least one of:
a first information element associated with an identity of the energy saving configuration,
a second information element associated with a percentage of energy saving of the energy saving configuration,
a third information element of at least one cell associated with the energy saving configuration,
at least one application condition of the energy saving configuration, or
a performance information element of the at least one cell when the energy saving configuration is applied; and
transmitting, to the DU, an indication of an active energy saving configuration from the set energy saving configurations, wherein the active energy saving configuration is to be activated for at least one cell.

2. The method of claim 1, wherein the set of energy saving configurations comprises at least one of:
a list of energy saving configurations to add,
a list of energy saving configurations to modify, or
a list of energy saving configurations to delete.

3. The method of claim 1, wherein the first information element comprises one of:
an energy saving index,
an energy saving level,
an energy consumption index, or
an energy consumption level.

4. The method of claim 1, wherein the third information element comprises at least one of:
a cell identity of the at least one cell,
an identity of the DU associated with the energy saving configuration,
frequency information of the at least one cell,
bandwidth information of the at least one cell,
an antenna configuration of the at least one cell,
a time domain resource configuration of the at least one cell,
a synchronization signal/physical broadcast channel block (SSB) configuration of the at least one cell, or
a physical random access channel (PRACH) configuration of the at least one cell.

5. The method of claim 1, wherein the at least one application condition comprises at least one of:
a resource condition for applying the energy saving configuration,
a hardware condition for applying the energy saving configuration,
a capacity condition for applying the energy saving configuration, or
the number of active terminal devices.

6. The method of claim 1, further comprising:
in accordance with a determination that one or more application conditions of the at least one application condition are satisfied, determining a target energy saving configuration associated with the at least one condition as the active energy saving configuration.

7. The method of claim 1, wherein the performance information element of the at least one cell comprises at least one of:
capacity information of the at least one cell,
coverage information of the at least one cell,
the number of active terminal devices in the at least one cell,
service type supported by the energy saving configuration,
service type not supported by the energy saving configuration, or
a quality of service parameter.

8. The method of claim 1, further comprising:
determining the active energy saving configuration from the set of energy saving configurations based on the performance information elements associated with the energy saving configurations in the set of energy saving configurations.

9. The method of claim 1, further comprising:
receiving, from the DU, a measurement result of the DU; and
determining the active energy saving configuration in the set of energy saving configurations based on the measurement result.

10. The method of claim 9, further comprising:
receiving, from the DU, a feedback message of the indication, the feedback message indicating whether the active energy saving configuration is activated at the DU.

11. The method of claim 1, further comprising:
receiving an energy saving update request from the DU, the energy saving update request indicating at least one candidate energy saving configuration; and
transmitting an energy saving update response to the DU.

12. A communication method, comprising:
transmitting, at a distributed unit (DU) of a network device, energy saving information to a centralized unit (CU) of the network device, the energy saving information comprising a set of energy saving configurations, and an energy saving configuration in the set of energy saving configurations indicating at least one of:
a first information element associated with an identity of the energy saving configuration,
a second information element associated with a percentage of energy saving of the energy saving configuration,
a third information element of at least one cell associated with the energy saving configuration,
at least one application condition of the energy saving configuration, or
a performance information element of the at least one cell when the energy saving configuration is applied; and
receiving, from the CU, an indication of an active energy saving configuration from the set energy saving configurations, wherein the active energy saving configuration is to be activated for at least one cell.

13. The method of claim 12, wherein the set of energy saving configurations comprises at least one of:
a list of energy saving configurations to add,
a list of energy saving configurations to modify, or
a list of energy saving configurations to delete.

14. The method of claim 12, wherein the first information element comprises one of:
an energy saving index,
an energy saving level,
an energy consumption index, or
an energy consumption level.

15. The method of claim 12, wherein the third information element comprises at least one of:
a cell identity of the at least one cell,
an identity of the DU associated with the energy saving configuration,
frequency information of the at least one cell,
bandwidth information of the at least one cell,
an antenna configuration of the at least one cell,
a time domain resource configuration of the at least one cell,
a synchronization signal/physical broadcast channel block (SSB) configuration of the at least one cell, or
a physical random access channel (PRACH) configuration of the at least one cell.

16. The method of claim 12, wherein the at least one application condition comprises at least one of:
a resource condition for applying the energy saving configuration,
a hardware condition for applying the energy saving configuration,
a capacity condition for applying the energy saving configuration, or
the number of active terminal devices.

17. The method of claim 12, wherein the performance information of the at least one cell comprises at least one of:
capacity information of the at least one cell,
coverage information of the at least one cell,
the number of active terminal devices in the at least one cell,
service type supported by the energy saving configuration,
service type not supported by the energy saving configuration, or
a quality of service parameter.

18. The method of claim 12, further comprising:
transmitting, to the CU, a measurement result of the DU.

19. The method of claim 12, further comprising: in accordance with a determination that the active energy saving configuration is different from a current energy saving configuration, activating the active energy saving configuration; or
in accordance with a determination that the active energy saving configuration is different from the current energy saving configuration, updating the current energy saving configuration.

20. The method of claim 19, further comprising:
transmitting, to the CU, a feedback message of the indication, the feedback message indicating whether the active energy saving configuration is activated at the DU.

21. The method of claim 12, further comprising:
transmitting an energy saving update request to the CU, the energy saving update request indicating at least one candidate energy saving configuration; and
receiving an energy saving update response from the CU.

22. A network device comprising:
a processor; and
a memory coupled to the processor and storing instructions thereon, the instructions, when executed by the processor, causing the network device to perform acts comprising the method according to any of claims 1-11.

23. A network device comprising:
a processor; and
a memory coupled to the processor and storing instructions thereon, the instructions, when executed by the processor, causing the network device to perform acts comprising the method according to any of claims 12-21.

24. A computer readable medium having instructions stored thereon, the instructions, when executed on at least one processor, causing the at least one processor to perform the method according to any of claims 1-11 or any of claims 12-21.
